(19) United States
(12) Patent Application Publication
(10) Pub. No.: US 2022/0287896 A1
(43) Pub. Date: Sep. 15, 2022

(54) SYSTEM FOR INTERCONNECTING A SLOUCH CORRECTION SHEET AND A PULLING STRAP

(71) Applicant: MacKenzie Health Care Technologies Ltd., Musquodoboit Harbour (CA)

(72) Inventors: Matthew MacKenzie, Musquodoboit Harbour (CA); Vincent Wilson, Musquodoboit Harbour (CA); Cong Su, Musquodoboit Harbour (CA); Darrell Luedey, Musquodoboit Harbour (CA)

(21) Appl. No.: 17/693,315

(22) Filed: Mar. 11, 2022

Related U.S. Application Data
(60) Provisional application No. 63/159,703, filed on Mar. 11, 2021.

(51) Int. Cl. A61G 7/05

(52) U.S. Cl. CPC A61G 7/05

(57) ABSTRACT

Disclosed herein is a system including a pulling strap having a distal end and a proximal end opposite the distal end, the pulling strap having an integral loop extending across a lateral width of the pulling strap at the proximal end; a slouch correction sheet including: a first end and a second end opposite the first end; a first tubular webbing integral with and extending across a first portion of the first end; a second tubular webbing integral with and extending across a second portion of the first end; wherein the first and second tubular webbings are in axial alignment and a gap between the first and second tubular webbings at about a midpoint of the first end is at least as great as the lateral width of the pulling strap at the proximal end; and a rigid connecting bar dimensioned to be simultaneously received within the first and second tubular webbings and the integral loop of the pulling strap while the integral loop is within the gap in axial alignment with the first and second tubular webbings, thereby to connect the pulling strap with the slouch correction sheet.

### CROSS-REFERENCE TO RELATED APPLICATION

This application claims priority to U.S. Provisional Patent Application Ser. No. 63/159,703 filed on Mar. 11, 2021 entitled “SYSTEM FOR INTERCONNECTING A SLOUCH CORRECTION SHEET AND A PULLING STRAP,” the contents of which are incorporated by reference herein.

### FIELD OF THE INVENTION

This application relates generally to slouch correction devices, and more particularly to a system for interconnecting a slouch correction sheet and a pulling strap of a slouch correction device.

### BACKGROUND OF THE INVENTION

U.S. Pat. No. 11,103,404 to MacKenzie et al. (the '404 patent), the contents of which are incorporated herein by reference, discloses a slouch correction device and method for use on a seating surface of a chair or bed. The device comprises a flexible fabric sheet—a slouch correction sheet—and a drawing mechanism associated with the fabric sheet. When the slouch correction device is associated with a chair, actuating the drawing mechanism draws the slouch correction sheet toward the back of the seating surface, thereby drawing the user toward the back support. When the slouch correction device is associated with a bed, actuating the drawing mechanism draws the slouch correction sheet towards the head of the bed, thereby drawing the user along the seating surface and back support of the bed toward the head of the bed.

The manner in which the slouch correction sheet and the drawing mechanism for drawing the slouch correction sheet are interconnected can affect the longevity, ease of use, and form factor of the slouch correction device.

### SUMMARY OF THE INVENTION

In accordance with an aspect of the following, there is provided a system comprising a pulling strap having a distal end and a proximal end opposite the distal end, the pulling strap having an integral loop extending across a lateral width of the pulling strap at the proximal end; a slouch correction sheet including: a first end and a second end opposite the first end; a first tubular webbing integral with and extending across a first portion of the first end; a second tubular webbing integral with and extending across a second portion of the first end; wherein the first and second tubular webbings are in axial alignment and a gap between the first and second tubular webbings at about a midpoint of the first end is at least as great as the lateral width of the pulling strap at the proximal end; and a rigid connecting bar dimensioned to be simultaneously received within the first and second tubular webbings and the integral loop of the pulling strap while the integral loop is within the gap in axial alignment with the first and second tubular webbings, thereby to connect the pulling strap with the slouch correction sheet.

In embodiments, the rigid connecting bar is substantially rectangular in cross-section.

In embodiments, the rigid connecting bar is removable from the first and second tubular webbings and the integral loop thereby to disconnect the pulling strap from the slouch correction sheet.

In embodiments, a side of the first tubular webbing opposite the gap is open or openable to enable insertion and removal of the rigid connecting bar.

In embodiments, a side of the second tubular webbing opposite the gap is closed or closeable to prevent removal of the rigid connecting bar.

Various embodiments and described and illustrated herein.

### BRIEF DESCRIPTION OF THE FIGURES

Embodiments will now be described more fully with reference to the accompany drawings, in which:

FIG. 1 is a top isometric view of a portion of a system having a slouch correction sheet interconnected with a pulling strap, according to an embodiment;

FIG. 2 is a top isometric sectional view of a portion of the slouch correction sheet interconnected with the pulling strap, with the tops of tubular webbings cut away for the purpose of aiding understanding;

FIG. 3 is a top isometric exploded view of a portion of the slouch correction sheet interconnected with the pulling strap;

FIG. 4 is a diagram of a pulling strap interconnected with the slouch correction sheet as in FIGS. 1 and 2, in association with a bed;

FIG. 5 is a diagram of the slouch correction sheet with integrated pillowcase and inserted pillow, shown with the pulling strap not interconnected;

FIG. 6 is a diagram of the slouch correction sheet with integrated pillowcase, with a rectangular rigid connecting bar extending partway out of one of the tubular webbings along the first end of slouch correction sheet;

FIG. 7 is a diagram of the proximal end of the pulling strap, showing for greater clarity the integral loop formed in proximal end of the pulling strap for receiving the rigid connecting bar;

FIG. 8 is a perspective view of the pulling strap interconnected with the slouch correction sheet and extending to a head of a support surface; and

FIG. 9 is a another perspective view of the pulling strap interconnected with the slouch correction sheet and extending to a head of the support surface.

### DETAILED DESCRIPTION

U.S. Pat. No. 11,103,404 to MacKenzie et al. (the '404 patent), the contents of which are incorporated herein by reference, discloses a slouch correction device and method for use on a seating surface of a chair or bed. The device comprises a flexible fabric sheet—a slouch correction sheet—and a drawing mechanism associated with the fabric sheet. When the slouch correction device is associated with a chair, actuating the drawing mechanism draws the slouch correction sheet toward the back of the seating surface, thereby drawing the user toward the back support. When the slouch correction device is associated with a bed, actuating the drawing mechanism draws the slouch correction sheet towards the head of the bed, thereby drawing the user along the seating surface and back support of the bed toward the head of the bed.

While the '404 patent is not limited to particular ways of interconnecting the drawing mechanism and the slouch correction sheet, the '404 patent proposes, as an embodiment, attaching the slouch correction sheet to a cylindrical drum of the drawing mechanism with multiple hook and loop fastened straps. The length of the cylindrical drum extends generally fully widthwise along the back of the chair or bed. The straps extend from respective points along one end of the slouch correction sheet—at the sides and in the middle of the end—and are each attached at respective points along the cylindrical drum. As the drum is rotated, in parallel the straps are progressively wound around (or unwound from) the drum, thereby drawing or slackening the slouch correction sheet based on the direction of rotation of the drum. Having straps extending from these multiple points along the end of the slouch correction sheet may be useful for avoiding the occurrence of bunching up of the fabric sheet as it is drawn. This may also be useful for reducing the extent to which the slouch correction sheet is pulled out of its generally desirable planar condition along the support surface, and for maintaining a suitable degree of tension on the slouch correction sheet that extends generally along the entire end of the sheet. In this configuration, the straps connect with the slouch correction sheet using the hook and loop, so that the slouch correction sheet can be easily removed as desired for cleaning and then re-attached to the straps after cleaning for further use.

However, it could be useful to provide alternative configurations of slouch correction devices that do not necessarily require the availability of a cylindrical drum extending fully widthwise along the back of a chair or bed. It would also be useful to provide such alternative slouch correction devices that also operate to inhibit the slouch correction sheet from unduly bunching up or being urged out of its generally desirable planar condition along the support surface.

In the present description, a system for interconnecting a slouch correction sheet and a pulling strap is provided. In an embodiment, a single pulling strap extends from a drawing mechanism that can wind and unwind the pulling strap around a drawing mechanism cylinder. The cylinder can be sized for accommodating just the single pulling strap, rather than multiple pulling straps as in the prior art, and can thus be smaller in size. The smaller size enables the drawing mechanism—which may include a motor, a cylinder, mounting components, and the like—to be more compact such that it can more easily be positioned with respect to various different configurations of support surfaces, whether they be beds, chairs, or some other support surfaces, and can remain discrete and unobtrusive. At the end of the pulling strap distal from the drawing mechanism, the pulling strap can be connected around the midpoint of a rigid connecting bar that itself extends across and is connected to the end of the slouch correction sheet. In this manner, when the pulling strap is drawn by the drawing mechanism, it pulls the rigid connecting bar from about the middle of the rigid connecting bar along with the pulling strap. In turn, the rigid connecting bar spreads the pulling force across the whole end of the slouch correction sheet, thereby keeping at least the end of the slouch correction sheet, and likely accordingly a significant portion of the slouch correction sheet downstream from the end, to remain in its generally desirable planar condition along the support surface.

It is preferable that the pulling strap is removably connectable to the rigid connecting bar, so that the pulling strap and the rigid connecting bar can be disconnected for maintenance or cleaning of components of the slouch correction system, including the slouch correction sheet. It is similarly preferable that the rigid connecting bar can itself be disconnected from the end of the slouch correction sheet, particularly so that the slouch correction sheet can be laundered, swapped out, replaced or otherwise changed. In embodiments disclosed, two aligned tubular webbings extend along the end of the slouch correction sheet, for receiving the rigid connecting bar. The tubular webbings are separated at the midpoint of the end, to accommodate the pulling strap interconnection with the rigid connecting bar. An end of one of the tubular webbings closest to a side of the sheet is closed, so that when the tubular webbings are receiving the rigid connecting bar, the rigid connecting bar can rest against the closed end rather than sliding through. An end of the other tubular webbing closest to the opposite side of the sheet at which the closed end of the other tubular webbing is located can be opened, or is open, to receive the end of the rigid connecting bar as the rigid connecting bar is slid into the tubular webbing. In embodiments, this end may be selectively closed, such as for example using a hook and loop flap, to inhibit the bar sliding out of the tubular webbings in that direction.

In embodiments, the rigid connecting bar is generally rectangular in cross-section (when viewed from one of its ends), and may have slightly rounded edges. A suitable rectangular cross-section inhibits rotation of the rigid connecting bar as it is drawn via the pulling strap by the drawing mechanism, and while a person is atop the slouch correction sheet. The longer surfaces of the rectangular cross-section are intended to run generally parallel to the general plane of the slouch correction sheet, and the shorter surfaces of the rectangular cross-section are intended to run perpendicular the general plane of the slouch correction sheet. It will be appreciated that, while other configurations of rigid connecting bar can be provided, a rigid connecting bar that is perhaps more cylindrical in cross section would function but may increase wear on the inside of the tubular webbing or on the pulling strap over time due to friction. By inhibiting rotation of the rigid connecting bar, it is expected that wear due to friction will be inhibited.

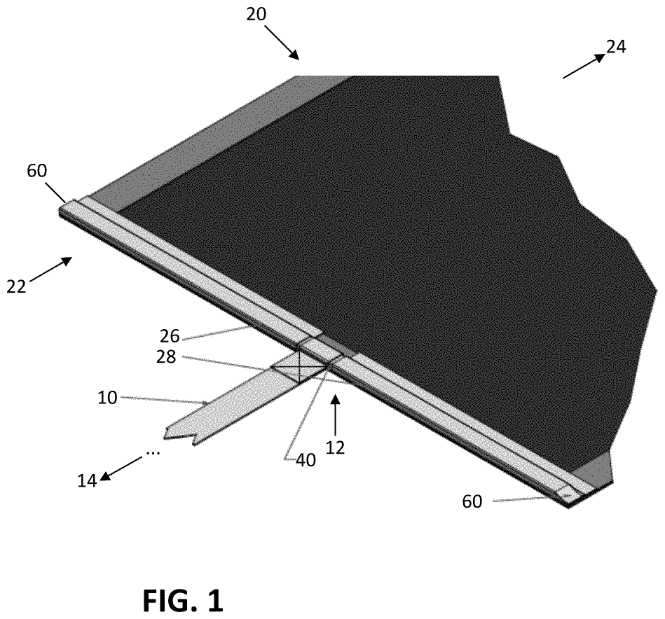

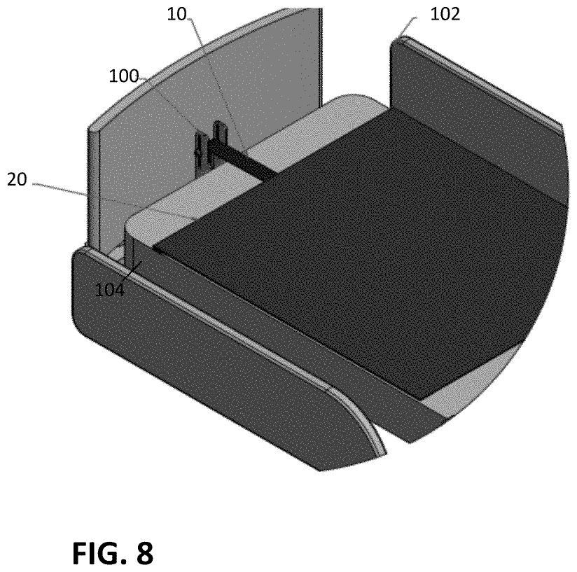

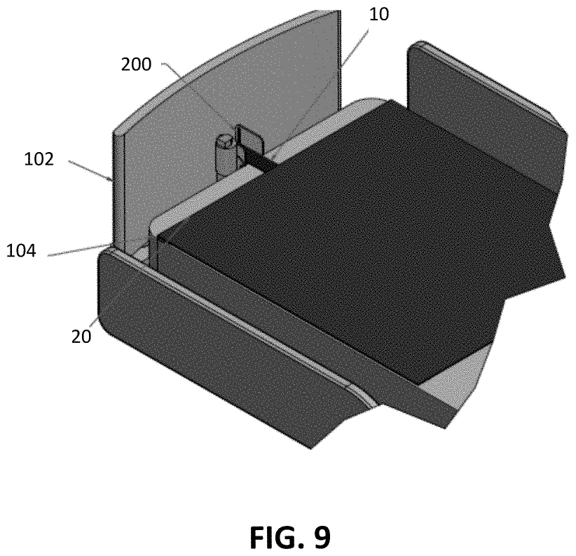

FIG. 1 is a top isometric view of a portion of a system having a slouch correction sheet 20 interconnected with a pulling strap 10, according to an embodiment. In this embodiment, pulling strap 10 has a distal end 12 and a proximal end 14 opposite the distal end 12. Pulling strap 10 also has an integral loop 16 extending across a lateral width of the pulling strap 10 at the proximal end 14. Slouch correction sheet 20 includes a first end 22 and a second end 24 opposite the first end. Slouch correction sheet 20 also includes a first tubular webbing 26 integral with and extending across a first portion of the first end 22, and a second tubular webbing 28 integral with and extending across a second portion of the first end 22. As can be seen, the first and second tubular webbings 26, 28 are in axial alignment: as tubes they align. However, a gap 30 is provided between the first and second tubular webbings 26, 28 at about a midpoint of the first end. Gap 30 is at least as great as the lateral width of the pulling strap 10 at the proximal end 14. Gap 30 has this size so that it can receive integral loop 16 of pulling strap 10 as will be shown and described. In this embodiment, a rigid connecting bar 40 is dimensioned in cross-sectional size and shape and in length to be simultaneously received within the first and second tubular webbings 26, 28 and the integral loop 16 of the pulling strap 10 while the integral loop 16 is within the gap 30 and in axial alignment with the first and second tubular webbings 26, 28. Rigid connecting bar 40 thereby connects the pulling strap 10 with the slouch correction sheet 20, such that tension of the slouch correction sheet 20 towards the second end 24 can be transmitted through the pulling strap 10 to the distal end 14 of the pulling strap, where it is associated with a drawing mechanism such as drawing mechanism 100 shown in FIG. 8 or drawing mechanism 200 shown in FIG. 9. Also, drawing of pulling strap 10 by such a drawing mechanism can transmit pulling force via rigid connection bar 40 across first end of slouch correction sheet 20 via first and second tubular webbings 26, 28.

In this embodiment, rigid connecting bar 40 is substantially rectangular in cross-section. Its edges may be rounded through machining in order to reduce the wear on the inner surfaces of the first and second tubular webbings 26, 28 and integral loop 16 of pulling strap 10. In this embodiment, rigid connecting bar 40 is formed of aluminum and extends about all of the way across the end of the slouch correction sheet. In alternative embodiments, rigid connecting bar 40 may extend slightly less than all the way across the first end 22 of slouch correction sheet 20. In this embodiment, the first and second tubular webbings 26, 28 are stitched along first end 22 of slouch correction sheet 20. At the side 60 of the second tubular webbing 28 opposite gap 30, second tubular webbing 28 is closed to capture rigid connecting bar 40 and prevent its removal from side 60. In embodiments, side 60 may not be permanently closed but may be closeable using a flap affixable using hook and loop or some other construction thereby to provide an operator with the option of reliably opening and closing side 60. Simlarly, a side 50 of the first tubular webbing 26 opposite gap 30 is open to enable insertion and removal of rigid connecting bar 40. In embodiments, side 50 may not be permanently open but may be openably using a flap affixable using hook and loop or some other construction thereby to provide an operator with the option of reliably opening and closing side 50.

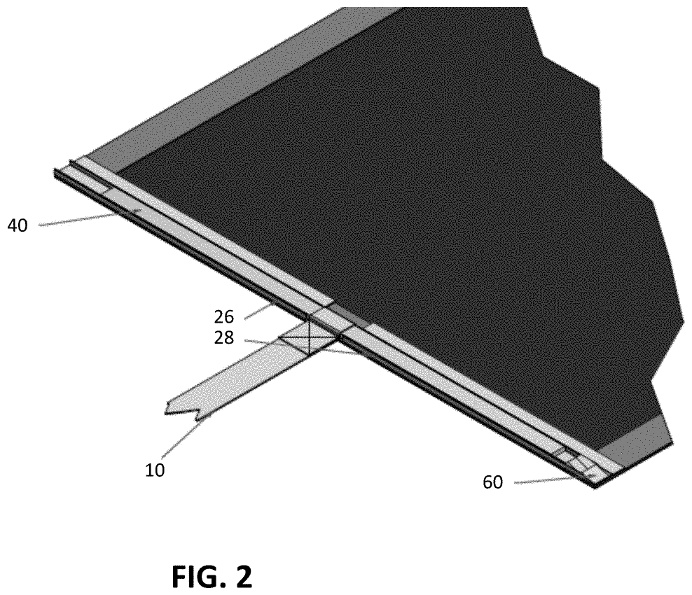

FIG. 2 is a top isometric sectional view of a portion of slouch correction sheet 20 interconnected with pulling strap 10, with the tops of tubular webbings 26, 28 cut away for the purpose of aiding understanding to show rigid connecting bar 40 extending about all of the way across the first end 22 of slouch correction sheet 20, and within the integral loop 16 of pulling strap 10.

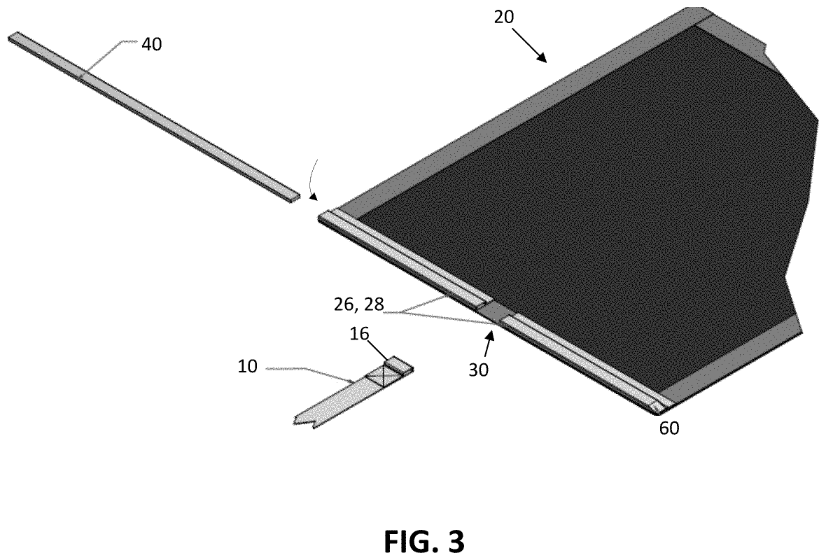

FIG. 3 is a top isometric exploded view of a portion of slouch correction sheet 20 interconnected with pulling strap 10. In order to interconnect slouch correction sheet 20 with pulling strap 10, an end of rigid connecting bar 40 is inserted into the left (open) side 50 of first tubular webbing 26 and is slid along first tubular webbing 26 until it reaches the opposite end of first tubular webbing 26 proximal gap 30. At this point, the end of rigid connecting bar 40 is inserted through integral loop 16 of pulling strap 10 so that integral loop 16 is axially aligned with both first and second tubular webbings 26, 28. Continued sliding of rigid connecting bar 40 in this direction causes it to enter into second tubular webbing 28 at a point proximal to gap 30 until it can reach a position that is generally centred along the first end 22 of slouch correction sheet 20. Removal of rigid connecting bar 40 to disconnect pulling strap 10 from rigid connecting bar 40, and accordingly from slouch correction sheet 20, is done by sliding rigid connecting bar 40 in the opposite direction so it can be removed from the opening at the left side 50 of first tubular webbing 26.

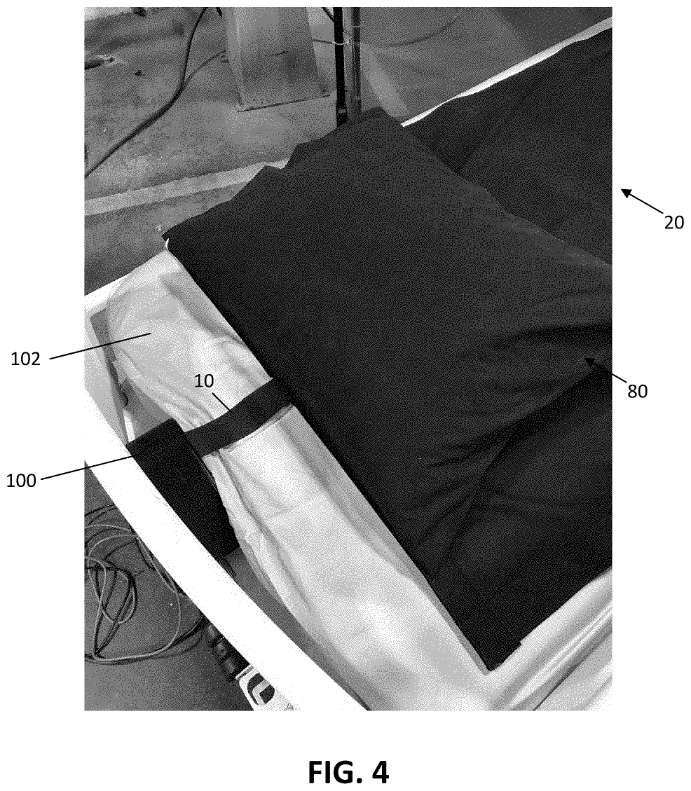

FIG. 4 is a diagram of pulling strap 10 interconnected with slouch correction sheet 20 as in FIGS. 1 and 2, in association with a bed 102. A pillow overlies the end of slouch correction sheet 20. It has been discovered that it is useful to attach a pillowcase to first end 22 of slouch correction sheet 20 so that the position of a pillow received by the pillowcase (for example, a patient's preferred pillow) with respect to slouch correction sheet 10 remains fixed. This also enables cushioning at the first end 22 along which rigid connecting bar 40 and tubular webbings 26, 28 extend, to inhibit a patient experiencing discomfort from these components.

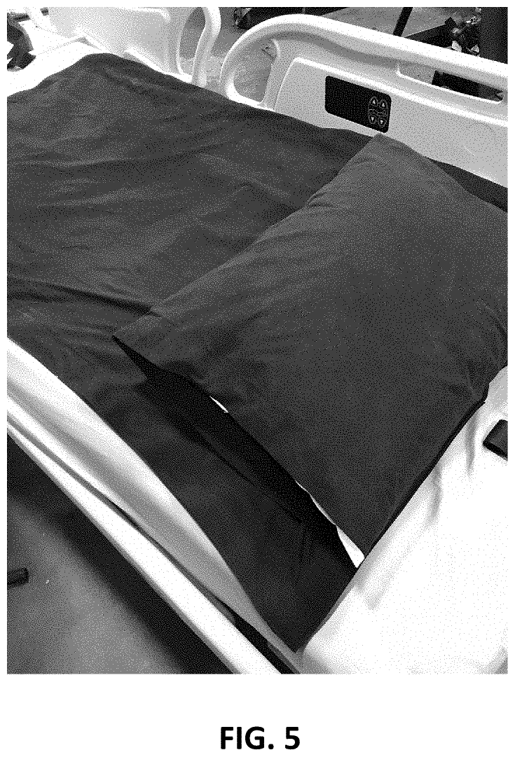

FIG. 5 is a diagram of slouch correction sheet 20 with integrated pillowcase and inserted pillow, shown with pulling strap 10 not interconnected.

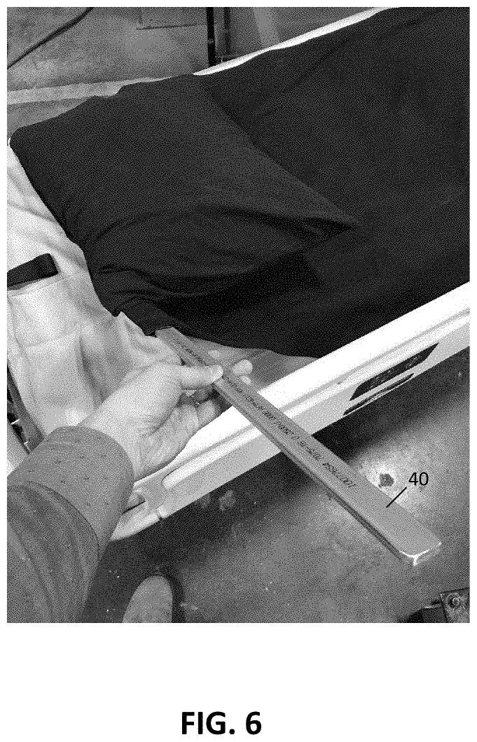

FIG. 6 is a diagram of slouch correction sheet 20 with integrated pillowcase, with a rectangular rigid connecting bar 40 extending partway out of one of the tubular webbings 26, 28 along the first end 22 of slouch correction sheet 20. Pulling strap 10 is thus, in this diagram, disconnected from slouch correction sheet 20.

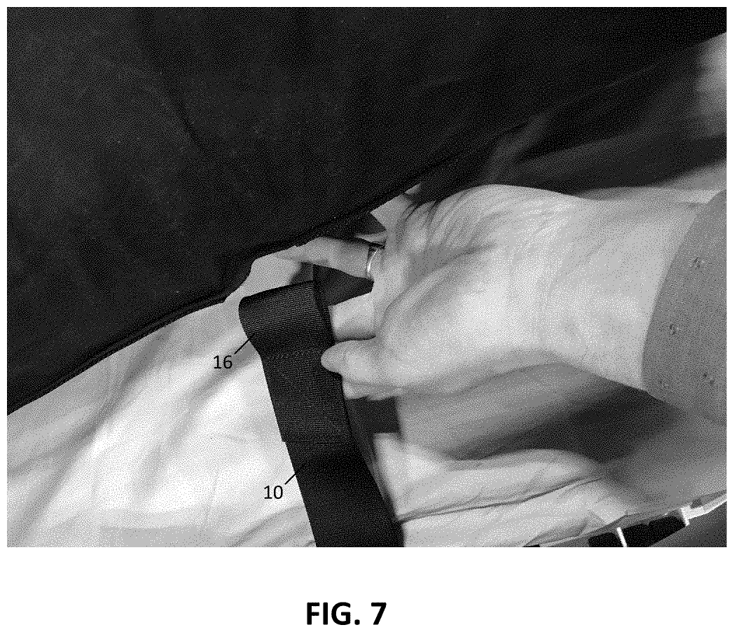

FIG. 7 is a diagram of the proximal end 14 of pulling strap 10, showing for greater clarity integral loop 16 formed in proximal end 14 of pulling strap 10 for receiving rigid connecting bar 40.

FIG. 8 is a perspective view of pulling strap 10 interconnected with slouch correction sheet 20 as described herein, and extending to a head of the support surface—in this example the head of a mattress 104—to reach components of a drawing mechanism 100. In this diagram, a drawing motor and cylinder of drawing mechanism 100 for wrapping pulling strap 10 are not shown, as this drawing mechanism 100 is an underbed design wherein the drawing motor and cylinder are underneath the bed.

FIG. 9 is a perspective view of pulling strap 10 interconnected with slouch correction sheet 20 as described herein, and extending to a head of the support surface—in this example the head of a mattress 104—to reach components of a drawing mechanism 200 according to an alternative embodiment. In this diagram, the cylinder of drawing mechanism 200 for wrapping pulling strap 10 is vertically oriented thereby to wrap pulling strap 10 around a vertical axis. Pulling strap 10 is therefore twisted by 90 degrees through from its proximal end 12 towards drawing mechanism 200. Alternatives are possible.

What is claimed is:

1. A system comprising:
a pulling strap having a distal end and a proximal end opposite the distal end, the pulling strap having an integral loop extending across a lateral width of the pulling strap at the proximal end;
a slouch correction sheet including:
a first end and a second end opposite the first end;
a first tubular webbing integral with and extending across a first portion of the first end;
a second tubular webbing integral with and extending across a second portion of the first end;
wherein the first and second tubular webbings are in axial alignment and a gap between the first and second tubular webbings at about a midpoint of the first end is at least as great as the lateral width of the pulling strap at the proximal end; and
a rigid connecting bar dimensioned to be simultaneously received within the first and second tubular webbings and the integral loop of the pulling strap while the integral loop is within the gap in axial alignment with the first and second tubular webbings, thereby to connect the pulling strap with the slouch correction sheet.

2. The system of claim 1, wherein the rigid connecting bar is substantially rectangular in cross-section.

3. The system of claim 1, wherein the rigid connecting bar is removable from the first and second tubular webbings and the integral loop thereby to disconnect the pulling strap from the slouch correction sheet.

4. The system of claim 3, wherein a side of the first tubular webbing opposite the gap is open or openable to enable insertion and removal of the rigid connecting bar.

5. The system of claim 4, wherein a side of the second tubular webbing opposite the gap is closed or closeable to prevent removal of the rigid connecting bar.
